(19) United States
(12) Patent Application Publication
(10) Pub. No.: US 2026/0202945 A1
(43) Pub. Date: Jul. 16, 2026

(54) MULTIMEDIA RESOURCE PRESENTATION

(71) Applicant: TENCENT TECHNOLOGY (SHENZHEN) COMPANY LIMITED, Shenzhen (CN)

(72) Inventor: Xinlei ZHANG, Shenzhen (CN)

(73) Assignee: TENCENT TECHNOLOGY (SHENZHEN) COMPANY LIMITED, Shenzhen (CN)

(21) Appl. No.: 19/564,664

(22) Filed: Mar. 12, 2026

Related U.S. Application Data
(63) Continuation of application No. PCT/CN2024/119379, filed on Sep. 18, 2024.

(30) Foreign Application Priority Data
Dec. 7, 2023 (CN) 202311690410.9

(51) Int. Cl. G06F 3/0483; G06F 3/01; G06F 3/0482; G06F 16/435; G06F 16/438

(52) U.S. Cl. CPC G06F 3/0483; G06F 3/013; G06F 3/0482; G06F 16/435; G06F 16/438

(57) ABSTRACT

In a multimedia resource presentation method, text content of to-be-read text is displayed. A reading-progress indicator configured to indicate a reading progress of the text content is displayed. Whether the reading progress indicated by the reading-progress indicator changes within a preset duration is determined. Resource recommendation information is displayed based on the text content and the reading progress indicated by the reading-progress indicator not changing within the preset duration. The resource recommendation information is configured to indicate a multimedia resource associated with the displayed text content. Resource presentation operation to view the resource recommendation information is received. The multimedia resource indicated by the resource recommendation information is presented based on the resource presentation operation.

### RELATED APPLICATIONS

The present application is a continuation of International Application No. PCT/CN2024/119379, filed on September 18, 2024, which claims priority to Chinese Patent Application No. 202311690410.9, filed on December 7, 2023. The entire disclosures of the prior applications are hereby incorporated by reference.

### FIELD OF THE TECHNOLOGY

This disclosure relates to the field of Internet technologies, including a presentation technology of a multimedia resource.

### BACKGROUND OF THE DISCLOSURE

When reading a text on a terminal, an object may be interested in a piece of content in the text. In this case, the object is likely to exit a presentation interface of the text, and enters another interface to search for a multimedia resource related to the content in which the object is interested. In this way, the related multimedia resource cannot be efficiently presented.

In a related technology, a part of content in the text is highlighted, to notify the object that the part of content is a hyperlink, and a secondary search can be performed, so that related content can be directly searched in the presentation interface of the text. However, different objects may be interested in different content. In other words, content that can be used for the secondary search may not be content in which the object is interested. As a result, the object still needs to exit the presentation interface of the text, and enters another interface for searching. Therefore, a multimedia resource presentation method is needed to improve interaction efficiency.

### SUMMARY

Embodiments of this disclosure provide a multimedia resource presentation method and apparatus, a device, and a storage medium. The method improves interaction efficiency, and accuracy of multimedia resource recommendation. Technical solutions include the following:

According to an aspect, a multimedia resource presentation method is provided. In the method, text content of to-be-read text is displayed. A reading-progress indicator configured to indicate a reading progress of the text content is displayed. Whether the reading progress indicated by the reading-progress indicator changes within a preset duration is determined. Resource recommendation information is displayed based on the text content and the reading progress indicated by the reading-progress indicator not changing within the preset duration. The resource recommendation information is configured to indicate a multimedia resource associated with the displayed text content. Resource presentation operation to view the resource recommendation information is received. The multimedia resource indicated by the resource recommendation information is presented based on the resource presentation operation.

According to an aspect, an information processing apparatus is provided. The information processing apparatus includes processing circuitry configured to display text content of a to-be-read text, and display a reading-progress indicator configured to indicate a reading progress of the text content. The processing circuitry is configured to determine whether the reading progress indicated by the reading-progress indicator changes within a preset duration, and display resource recommendation information based on the text content and the reading progress indicated by the reading-progress indicator not changing within the preset duration. The resource recommendation information is configured to indicate a multimedia resource associated with the displayed text content. The processing circuitry is configured to receive a resource presentation operation to view the resource recommendation information. The processing circuitry is configured to present, based on the resource presentation operation, the multimedia resource indicated by the resource recommendation information.

According to an aspect, a non-transitory computer readable storage medium storing instructions which, when executed by a processor, causes the processor to perform any of the multimedia resource presentation methods.

According to an aspect, a multimedia resource presentation method is provided, and is performed by a terminal. The method includes: presenting text content of a to-be-read text on a text presentation interface, a reading progress indication being displayed on the text presentation interface, and the reading progress indication being configured to indicate a text reading progress corresponding to the text content; displaying resource recommendation information if the text reading progress indicated by the reading progress indication does not change within preset duration, the resource recommendation information being configured to indicate a multimedia resource, and the multimedia resource being a multimedia resource associated with the presented text content; and presenting, in response to a resource presentation operation on the text presentation interface, the multimedia resource indicated by the resource recommendation information.

According to an aspect, a multimedia resource presentation method is provided, and is performed by a server. The method includes: receiving first content transmitted by a terminal, the first content being text content in a to-be-read text that is presented on a text presentation interface of the terminal, a reading progress indication configured to indicate a text reading progress corresponding to the presented text content being displayed on the text presentation interface, and the terminal being configured to transmit the first content when the text reading progress indicated by the reading progress indication does not change within preset duration; performing searching based on the first content, to obtain a multimedia resource associated with the first content; and transmitting the multimedia resource to the terminal, the terminal being configured to present resource recommendation information to indicate the multimedia resource.

According to an aspect, a multimedia resource presentation apparatus is provided, and is deployed on a terminal. The apparatus includes: a content presentation module, configured to present text content of a to-be-read text on a text presentation interface, a reading progress indication being displayed on the text presentation interface, and the reading progress indication being configured to indicate a text reading progress corresponding to the text content; an information presentation module, configured to display resource recommendation information if the text reading progress indicated by the reading progress indication does not change within preset duration, the resource recommendation information being configured to indicate a multimedia resource, and the multimedia resource being a multimedia resource associated with the presented text content; and a resource presentation module, configured to present, in response to a resource presentation operation on the text presentation interface, the multimedia resource indicated by the resource recommendation information.

According to an aspect, a multimedia resource presentation apparatus is provided, and is deployed on a server. The apparatus includes: a receiving module, configured to receive first content transmitted by a terminal, the first content being text content in a to-be-read text that is presented on a text presentation interface of the terminal, a reading progress indication configured to indicate a text reading progress corresponding to the presented text content being displayed on the text presentation interface, and the terminal being configured to transmit the first content when the text reading progress indicated by the reading progress indication does not change within preset duration; a search module, configured to perform searching based on the first content, to obtain a multimedia resource associated with the first content; and a transmitting module, configured to transmit the multimedia resource to the terminal, the terminal being configured to present resource recommendation information to indicate the multimedia resource.

According to an aspect, a computer device is provided. The computer device includes processing circuitry (e.g., a processor) and a memory, the memory being configured to store at least one instruction, the at least one program being loaded and executed by the processing circuitry to implement the multimedia resource presentation methods in embodiments of this disclosure.

According to an aspect, a computer-readable storage medium (e.g., a non-transitory computer-readable storage medium) is provided, the computer-readable storage medium stores at least one program, the at least one program being loaded and executed by a processor to implement the multimedia resource presentation methods in embodiments of this disclosure.

According to an aspect, a computer program product is provided. The computer program product includes at least one program, the at least one program being stored in a computer-readable storage medium (e.g., a non-transitory computer-readable storage medium), a processor of a computer device reading the at least one program from the computer-readable storage medium, and the processor executing the at least one program, to enable the computer device to perform the multimedia resource presentation methods in embodiments of this disclosure.

An embodiment of this disclosure provides a multimedia resource presentation method. In the method, when an object reads a text, text content in a to-be-read text is displayed on a text presentation interface. A reading progress indication is further displayed on the text presentation interface. The reading progress indication is configured to indicate a text reading progress corresponding to the presented text content. In other words, the text reading progress indicated by the reading progress indication does not change, which indicates that the text content read by the object does not change. If the text reading progress indicated by the reading progress indication does not change within preset duration, it indicates that the object keeps viewing the currently presented text content, that is, the object is interested in the currently presented text content. However, in this case, resource recommendation information is displayed, to remind the object that a multimedia resource associated with the currently presented text content is recommended, so that after the object performs an interaction operation, the recommended multimedia resource can be viewed and the object does not need to switch to another interface to search for the related multimedia resource, which improves interaction efficiency. In addition, the method is used to determine content in which the object is interested based on a reading behavior of the object, so that the determined content in which the object is interested is accurate. Further, the multimedia resource related to the content in which the object is interested is recommended to the object, which improves accuracy of multimedia resource recommendation. The method improves the interaction efficiency, and improves the accuracy of multimedia resource recommendation.

### BRIEF DESCRIPTION OF THE DRAWINGS

FIG. 1 is a schematic diagram of an implementation environment according to an embodiment of this disclosure.

FIG. 2 is a flowchart of a multimedia resource presentation method according to an embodiment of this disclosure.

FIG. 3 is a flowchart of another multimedia resource presentation method according to an embodiment of this disclosure.

FIG. 4 is a flowchart of another multimedia resource presentation method according to an embodiment of this disclosure.

FIG. 5 is a schematic diagram of a text presentation interface according to an embodiment of this disclosure.

FIG. 6 is a schematic diagram of another text presentation interface according to an embodiment of this disclosure.

FIG. 7 is a schematic diagram of an interface for presenting a multimedia resource according to an embodiment of this disclosure.

FIG. 8 is a schematic diagram of another interface for presenting a multimedia resource according to an embodiment of this disclosure.

FIG. 9 is a schematic diagram of another interface for presenting a multimedia resource according to an embodiment of this disclosure.

FIG. 10 is a flowchart of an interface of an interaction process of a navigation bar according to an embodiment of this disclosure.

FIG. 11 is a flowchart of another multimedia resource presentation method according to an embodiment of this disclosure.

FIG. 12 is a flowchart of another multimedia resource presentation method according to an embodiment of this disclosure.

FIG. 13 is a flowchart of another multimedia resource presentation method according to an embodiment of this disclosure.

FIG. 14 is a block diagram of a multimedia resource presentation apparatus according to an embodiment of this disclosure.

FIG. 15 is a block diagram of a multimedia resource presentation apparatus according to an embodiment of this disclosure.

FIG. 16 is a block diagram of a terminal according to an embodiment of this disclosure.

FIG. 17 is a block diagram of a server according to an embodiment of this disclosure.

### DETAILED DESCRIPTION

To make objectives, technical solutions, and advantages of this disclosure clearer, examples of implementations of this disclosure are further described below with reference to accompanying drawings.

The terms "first", "second", and the like in this disclosure are used to distinguish between same items or similar items of which effects and functions are basically the same. The "first", the "second", and the "n^{th}" do not have a dependency relationship in logic or time sequence, and a quantity and an execution order thereof are not limited.

In this disclosure, the term "at least one" means one or more, and "a plurality of" means two or more.

In the following description, the use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

An example implementation environment involved in this disclosure is introduced below.

The multimedia resource presentation method provided in the embodiments of this disclosure can be performed by a computer device. The computer device may be provided as a server or a terminal. The following introduces a schematic diagram of an implementation environment of a multimedia resource presentation method according to an embodiment of this disclosure.

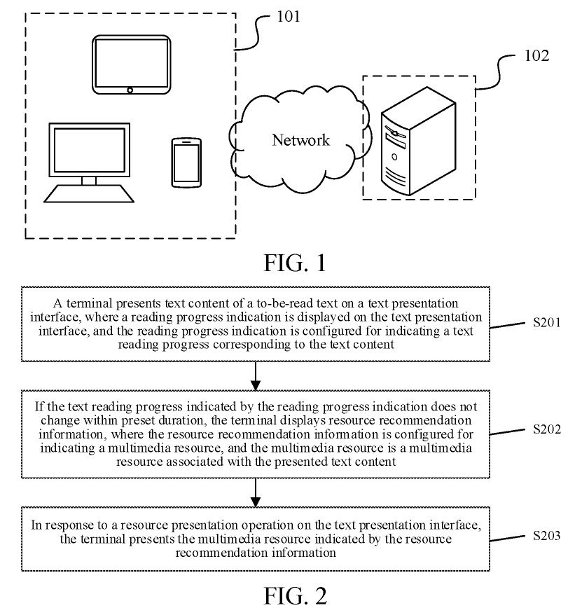

FIG. 1 is a schematic diagram of an implementation environment of a multimedia resource presentation method according to an embodiment of this disclosure. The implementation environment includes a terminal 101, and a server 102. The terminal 101 and the server 102 can be directly or indirectly connected in a wired or wireless communication manner, and are not limited in this disclosure. In an embodiment, the terminal 101 is configured to display a text presentation interface, and present a text on the text presentation interface. Further, the terminal 101 is further configured to present a multimedia resource associated with the presented text content on the text presentation interface. The server 102 is configured to provide a backend service for the terminal 101 to present the text and the multimedia resource. In an embodiment, a search application is installed on the terminal 101, and the text presentation interface is an interface in the search application. The server 102 is a backend server of the search application, and is configured to provide a backend service for the search application. In this way, based on a strong search capability of the search application, rich and accurate multimedia resources can be provided for the terminal 101.

In an embodiment, a reading application configured for text reading is installed on the terminal 101. For example, the reading application is a book reader, a novel reader, an ebook reader, or the like. Further, these readers also have a reading progress indication function. For example, during use of these readers, a reading progress indication is displayed on a text presentation interface of each of these readers, and the reading progress indication is configured to indicate a current reading progress of the text. Further, the reading application further has a search function for the multimedia resource, so that in a process of performing text reading in the reading application, the multimedia resource related to the text content is recommended through the search function. Alternatively, the reading application is in communication connection with the search application, so that in the process of performing text reading in the reading application, the multimedia resource related to the text content is recommended to the reading application through the search application.

A type of the terminal device 101 or the server 102 is not limited in this disclosure.

In an embodiment, the terminal device 101 may be a smartphone, a tablet computer, a notebook computer, a desktop computer, a smart speech interaction device, a smart household appliance, an in-vehicle terminal, an aircraft, a virtual reality (VR) apparatus, an augmented reality (AR) apparatus, and the like. However, this is not limited thereto. In an embodiment, the server 102 may be an independent server, or may be a server cluster or a distributed system formed by a plurality of servers, or may also be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In an embodiment, the server 102 is responsible for primary computing work, and the terminal 101 is responsible for secondary computing work; or the server 102 is responsible for secondary computing work, and the terminal 101 is responsible for primary computing work; or a distributed computing architecture is used between the server 102 and the terminal 101 to perform collaborative computing.

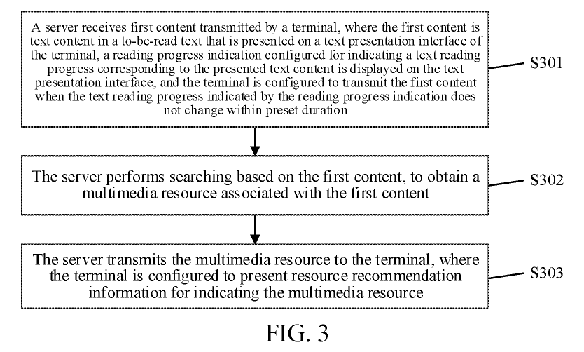

FIG. 2 is a flowchart of a multimedia resource presentation method according to an embodiment of this disclosure. The method is performed by a terminal, and the method includes the following operations:

201: The terminal presents text content of a to-be-read text on a text presentation interface, where a reading progress indication is displayed on the text presentation interface, and the reading progress indication is configured to indicate a text reading progress corresponding to the text content. In an example, text content of to-be-read text and a reading-progress indicator configured to indicate a reading progress of the text content are displayed.

The to-be-read text is a text that an object (e.g., a user) needs to read. The to-be-read text may be long or may also be short. When the to-be-read text is long, the text content presented on the text presentation interface may be a part of content of the to-be-read text. When the to-be-read text is short, the text content presented on the text presentation interface may be entire content of the to-be-read text. An embodiment of this disclosure is described mainly by using an example in which the text content presented on the text presentation interface may be the part of content of the to-be-read text.

To avoid obstruction of the presented text content that is caused by the reading progress indication, the reading progress indication is displayed in a boundary region of the text presentation interface. Further, a display position of the reading progress indication on the text presentation interface varies with the text reading progress. For example, the reading progress indication is displayed in a right boundary region of the text presentation interface. A more front text reading progress indicates a higher display position of the reading progress indication, and a more rear text reading progress indicates a lower display position of the reading progress indication.

In an embodiment, the reading progress indication may be text information, or may be a navigation bar. A display position of the navigation bar is configured to indicate the text reading progress corresponding to the presented content.

In an embodiment, an example in which the reading progress indication is the navigation bar is used for description. The navigation bar is displayed in the boundary region of the text presentation interface. Further, the navigation bar is displayed on a left side edge or a right side edge of the boundary region.

In an embodiment, when the to-be-read text is long, the part of content of the to-be-read text is presented on the text presentation interface. In this case, content in the text content presented on the text presentation interface may be switched based on a content switching operation. The content switching operation may be an up-swiping operation, a down-swiping operation, a left-swiping operation, a right-swiping operation, or a tapping operation. In an embodiment, an example in which the content switching operation is the up-swiping operation or the down-swiping operation is used for description.

In an embodiment, a more front position of the text content that is currently presented on the text presentation interface and that is in the to-be-read text indicates a higher display position of the navigation bar on the text presentation interface. The display position of the navigation bar is changed in response to the content switching operation. For example, in response to the up-swiping operation on the text presentation interface, the display position of the navigation bar is moved upward; and in response to the down-swiping operation on the text presentation interface, the display position of the navigation bar is moved downward.

202: If the text reading progress indicated by the reading progress indication does not change within preset duration, the terminal displays resource recommendation information, where the resource recommendation information is configured to indicate a multimedia resource, and the multimedia resource is a multimedia resource associated with the presented text content. In an example, whether the reading progress indicated by the reading-progress indicator changes within a preset duration is determined. Resource recommendation information is displayed based on the text content and the reading progress indicated by the reading-progress indicator not changing within the preset duration. The resource recommendation information is configured to indicate a multimedia resource associated with the displayed text content.

In an embodiment, in response to the content switching operation on the text presentation interface being not detected by the terminal within the preset duration, it is determined that the text reading progress indicated by the reading progress indication does not change. When the to-be-read text is very long, and the part of content of the to-be-read text is presented on the text presentation interface, the terminal detects no content switching operation on the text presentation interface within the preset duration, that is, the text content presented on the text presentation interface does not change.

In an embodiment, the display position of the reading progress indication varies with the text reading progress. Correspondingly, whether the text reading progress changes can be determined based on whether the display position of the reading progress indication changes. For example, if the reading progress indication is the navigation bar, that the text reading progress indicated by the reading progress indication does not change means that the display position of the navigation bar does not change.

If the reading progress indication is the text information, for example, 50%, that the text reading progress indicated by the reading progress indication does not change means that the text information of the reading progress indication does not change.

In an embodiment, the reading progress indication is the navigation bar, and words configured to indicate the text reading progress are displayed on the navigation bar.

In an embodiment, the multimedia resource is obtained by searching based on the text content. For example, the multimedia resource is obtained by searching through the search application based on the text content.

In an embodiment, the terminal displays the resource recommendation information, to prompt the text presentation interface to recommend the multimedia resource associated with the currently presented content.

In an embodiment, a manner of displaying the resource recommendation information may be displaying the resource recommendation information on the reading progress indication, so that a space additionally occupied by the resource recommendation information is reduced, and the obstruction of the presented text content is avoided.

203: In response to a resource presentation operation on the text presentation interface, the terminal presents the multimedia resource indicated by the resource recommendation information. In an example, resource presentation operation to view the resource recommendation information is received. The multimedia resource indicated by the resource recommendation information is presented based on the resource presentation operation.

In an embodiment, the terminal may present the multimedia resource on the text presentation interface, or may jump to another interface to present the multimedia resource. In an embodiment, an example in which the multimedia resource is presented on the text presentation interface is used for description.

An embodiment of this disclosure provides the multimedia resource presentation method. In the method, when the object reads the text, the text content in the to-be-read text is displayed on the text presentation interface. The reading progress indication is further displayed on the text presentation interface. The reading progress indication is configured to indicate the text reading progress corresponding to the presented text content. In other words, the text reading progress indicated by the reading progress indication does not change, which indicates that the text content read by the object does not change. If the text reading progress indicated by the reading progress indication does not change within the preset duration, it indicates that the object keeps viewing the currently presented text content, that is, the object is interested in the currently presented text content. However, in this case, the resource recommendation information is displayed, to remind the object that the multimedia resource associated with the currently presented text content is recommended, so that after the object performs the interaction operation, the recommended multimedia resource can be viewed and the object does not need to switch to another interface to search for the related multimedia resource, which improves interaction efficiency. In addition, the method is used to determine content in which the object is interested based on a reading behavior of the object, so that the determined content in which the user is interested is accurate. Further, the multimedia resource related to the content in which the user is interested is recommended to the object, which improves accuracy of multimedia resource recommendation. The method improves the interaction efficiency, and ensures the accuracy of multimedia resource recommendation.

In an embodiment, the terminal obtains the content that is read by the object on the terminal (that is, the text content presented on the text presentation interface) in a case in which authorization of the object is obtained. An authorization interface is displayed on the terminal used by the object, and prompt information, an OK control, and a NO control are displayed on the authorization interface. The prompt information is configured to indicate to obtain the content read by the object on the terminal. The OK control is configured to indicate that the object has granted permission for the terminal to obtain the content read by the object on the terminal. In response to a trigger operation on the OK control, the terminal obtains the content read by the object on the terminal.

The foregoing describes, based on the embodiment in FIG. 2, a process of presenting the multimedia resource by using the terminal as an execution body. The following describes a process of presenting the multimedia resource by using a server as an execution body. FIG. 3 is a flowchart of a multimedia resource presentation method according to an embodiment of this disclosure. The method is performed by a server, and the method includes the following operations.

301: The server receives first content transmitted by a terminal, where the first content is text content in a to-be-read text that is presented on a text presentation interface of the terminal, a reading progress indication configured to indicate a text reading progress corresponding to the presented text content is displayed on the text presentation interface, and the terminal is configured to transmit the first content when the text reading progress indicated by the reading progress indication does not change within preset duration.

In an embodiment, the text presentation interface, the reading progress indication, and the like in operation 301 are similar to those in operation 201, and details are not described herein again.

302: The server performs searching based on the first content, to obtain a multimedia resource associated with the first content.

In an embodiment, the server may perform searching based on a search server. Correlation between the multimedia resource and the first content is greater than correlation threshold.

303: The server transmits the multimedia resource to the terminal, where the terminal is configured to present resource recommendation information to indicate the multimedia resource.

In an embodiment, a process of presenting the multimedia resource by the terminal is similar to the foregoing operation 202 and operation 203, and details are not described herein again.

An embodiment of this disclosure provides the multimedia resource presentation method. In the method, when an object reads a text, the text content in the to-be-read text is displayed on the text presentation interface. The reading progress indication is further displayed on the text presentation interface. The reading progress indication is configured to indicate the text reading progress corresponding to the presented text content. In other words, the text reading progress indicated by the reading progress indication does not change, which indicates that the text content read by the object does not change. If the text reading progress indicated by the reading progress indication does not change within the preset duration, it indicates that the object keeps viewing the currently presented text content, that is, the object is interested in the currently presented text content. However, the text content in which the object is interested, namely, the first content is transmitted to the server in this case, so that the server performs searching based on the first content, to obtain the related multimedia resource, and the related multimedia resource is further returned to the terminal for presenting. In the method, the object does not need to switch to another interface to search for the related multimedia resource, which improves interaction efficiency. In addition, the method is used to determine content in which the object is interested based on a reading behavior of the object, so that the determined content in which the object is interested is accurate. Further, the multimedia resource related to the content in which the object is interested is recommended to the object, which improves accuracy of multimedia resource recommendation. The method improves the interaction efficiency, and ensures the accuracy of multimedia resource recommendation.

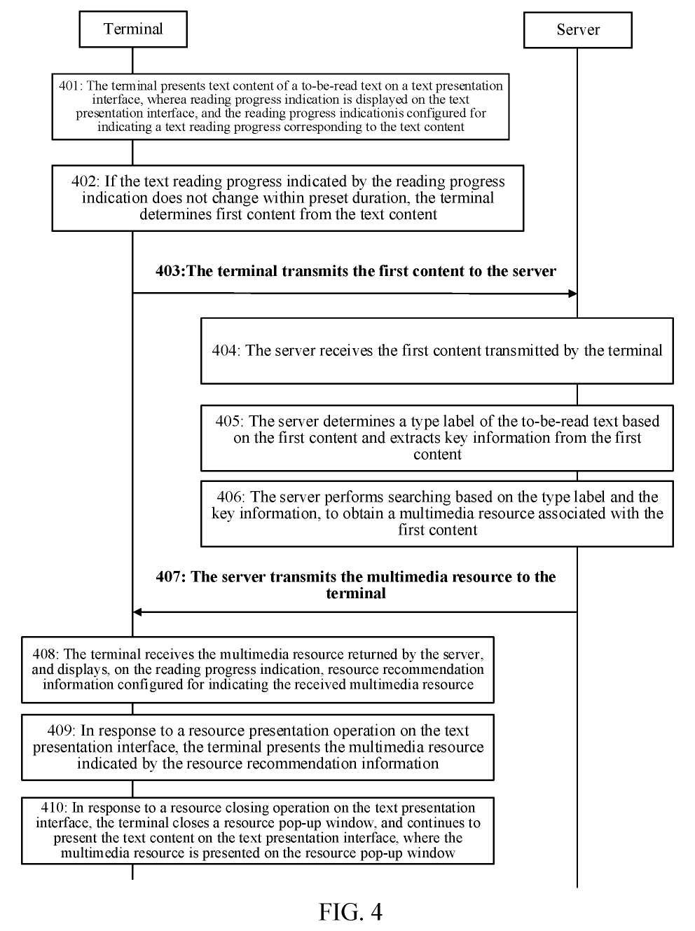

The multimedia resource presentation method is briefly introduced through the embodiments of FIG. 2 and FIG. 3. The multimedia resource presentation method is further explained in detail below based on an embodiment of FIG. 4. FIG. 4 is a multimedia resource presentation method according to an embodiment of this disclosure. The method is described by using interaction between a terminal and a server as an example. The method includes the following operations.

401: The terminal presents text content of a to-be-read text on a text presentation interface, where a reading progress indication is displayed on the text presentation interface, and the reading progress indication is configured to indicate a text reading progress corresponding to the text content.

In an embodiment, in response to an entry operation on the text presentation interface, the terminal enters the text presentation interface. The entry operation on the text presentation interface may be set and modified according to a requirement. For example, an entry control of the text presentation interface is displayed on the terminal. In response to a trigger operation on the text presentation interface, the terminal displays the text presentation interface. For another example, a text cover of the text is displayed on the terminal. In response to a trigger operation on the text cover, the terminal displays the text presentation interface.

In an embodiment, an example in which the reading progress indication is a navigation bar is used for description. A shape and a size of the navigation bar may be set and modified according to a requirement. The navigation bar is in a strip-shaped structure, and a length and a width of the navigation bar may be set and modified according to a requirement.

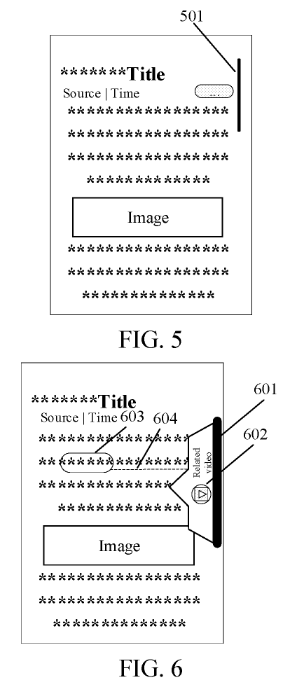

For example, FIG. 5 is a schematic diagram of a text presentation interface according to an embodiment of this disclosure. A navigation bar 501 is displayed on a right side edge of the text presentation interface.

402: If the text reading progress indicated by the reading progress indication does not change within preset duration, the terminal determines first content from the text content.

In an embodiment, a display position of the reading progress indication varies with the text reading progress. In an embodiment, an example in which the reading progress indication is the navigation bar is used for description. That the text reading progress indicated by the reading progress indication does not change within the preset duration means that a text reading progress indicated by the navigation bar does not change within preset duration.

In an embodiment, the preset duration may be set and modified according to a requirement. For example, the preset duration is 1 second.

In an embodiment, the process in which the foregoing terminal determines, based on the text content, to transmit the first content to the server includes at least one of the following three implementations.

In an implementation, the terminal determines the presented text content as the first content. In this implementation, the text content is directly determined as the first content, that is, the multimedia resource is further determined based on entire content presented on the text presentation interface, which can improve richness and diversity of the multimedia resource.

In another implementation, the terminal determines content corresponding to the display position of the reading progress indication in the text content as the first content. In this implementation, if the reading progress indication is set on the text presentation interface, content read by the object is usually the content corresponding to the display position of the reading progress indication. Further, the text content is used as the first content to determine the multimedia resource, so that the multimedia resource recommended to the object is more accurate.

In another implementation, the terminal determines, based on gaze detection, content corresponding to gaze of the object. If the content corresponding to the gaze of the object belongs to the content corresponding to the display position of the reading progress indication, the content corresponding to the gaze of the object is determined as the first content.

If the content corresponding to the gaze of the object does not belong to the content corresponding to the display position of the reading progress indication, the content corresponding to the display position of the reading progress indication in the text content is determined as the first content. In an embodiment, the terminal performs gaze detection through a front-facing camera.

In an embodiment, the content read by the object is further determined based on the gaze of the object, to further improve accuracy of the first content, so that the multimedia resource recommended to the object is more accurate.

In an embodiment, the content corresponding to the display position of the reading progress indication is determined through the following operation: The terminal determines a target region corresponding to the display position of the reading progress indication, and uses content in the target region as the content corresponding to the display position of the reading progress indication.

The terminal determines positions of vertexes at two ends of the reading progress indication. Line extension starts from the vertexes at the two ends toward the other boundary that is opposite to the display position of the reading progress indication on the text presentation interface until the other boundary is reached, to obtain two parallel straight lines, and a region between the two straight lines is used as the target region. The other two boundaries of the target region are respectively boundaries of the text.

In an embodiment, the terminal further performs gaze detection. If it is determined, through gaze detection, that the gaze of the object stays on the text presentation interface, and the text reading progress indicated by the reading progress indication does not change within the preset duration, the terminal determines the first content from the text content. Correspondingly, if the text reading progress indicated by the reading progress indication does not change within the preset duration, the process in which the terminal displays the resource recommendation information on the reading progress indication includes the following operation: If it is determined, through gaze detection, that the gaze of the object stays on the text presentation interface, and the text reading progress indicated by the reading progress indication does not change within the preset duration, the terminal displays the resource recommendation information.

In an embodiment, when the gaze of the object stays on the text presentation interface, it indicates that the object is indeed reading the content presented on the text presentation interface in this case. In this way, when stay duration of the gaze of the object on the text presentation interface is relatively long, the multimedia resource is recommended to the object, to further improve accuracy of recommending the multimedia resource to the object, so that resource waste is avoided.

403: The terminal transmits the first content to the server.

In an embodiment, the terminal may compress the first content and transmit the compressed first content to the server. The server is configured to determine the multimedia resource based on the first content.

404: The server receives the first content transmitted by the terminal.

In an embodiment, the server is configured to search the multimedia resource based on the first content.

405: The server determines a type label of the to-be-read text based on the first content and extracts key information in the first content.

The type label of the to-be-read text is configured to indicate a style to which the to-be-read text belongs, for example, is configured to indicate that the to-be-read text is a news report, an exposition, or an argumentation. Alternatively, the type label of the to-be-read text is configured to indicate a field to which the to-be-read text belongs, for example, indicating that the to-be-read text is a science and technology text. Further, the type label of the to-be-read text indicates both the style to which the to-be-read text belongs and the field to which the to-be-read text belongs, which are not limited herein.

In an embodiment, the first content may be a paragraph, a sentence, or a word. If the first content is the word, the word is used as the key information. If the first content is the sentence, the sentence is split, and a plurality of words obtained through splitting are respectively used as the key information. If the first content is the paragraph, the paragraph is split, a plurality of obtained sentences are respectively used as the key information, and the plurality of sentences are respectively split, to use a plurality of obtained words as the key information.

In an embodiment, the server further filters the plurality of sentences and the plurality of words that are obtained through splitting, and uses a sentence or a word that meets a target condition as the key information. For example, the target condition may be content that is preferred by the object and that is indicated by reading preference information of the object, or may be a searching threshold that is reached by a quantity of times of searching for the sentence or the word, or may be a combination of the two, which is not limited herein.

In an embodiment, the terminal determines the type label of the to-be-read text and extracts the key information in the first content based on the first content, and transmits the type label and the key information to the server.

In an embodiment, the server obtains entire content of the to-be-read text, and further determines the type label of the to-be-read text based on the entire content of the to-be-read text. Further, the terminal transmits a position of the first content to the server, and the server determines the first content based on the obtained text and the obtained position.

406: The server performs searching based on the type label and the key information, to obtain a multimedia resource associated with the first content.

In an embodiment, the server may separately use the type label and the key information as search conditions to perform searching, to obtain multimedia resources respectively corresponding to the type label and the key information. Alternatively, the server may use the type label and the key information as a comprehensive search condition to perform searching, to obtain a multimedia resource corresponding to both the type label and the key information. For example, the comprehensive search condition C1 may be C1 = label+ A01, A02, A03, and the like. A01, A02, and A03 separately represent a type of key information.

In an embodiment, there are a plurality of pieces of key information, and the server separately combines each piece of key information with the type label, to obtain a plurality of search conditions; or at least two combinations are formed between the plurality of pieces of key information and the type label, to obtain a plurality of search conditions. Then, searching is performed based on the plurality of search conditions, to obtain a multimedia resource respectively corresponding to the plurality of search conditions.

In an embodiment, the process in which the server performs searching based on the type label and the key information, to obtain the multimedia resource associated with the first content includes the following operation: The server performs searching based on the type label and the key information, to obtain a candidate multimedia resource. The foregoing process in which the server determines the multimedia resource based on the candidate multimedia resource includes the following several implementations.

In an implementation, the server determines an association degree (e.g., a first association degree) between the candidate multimedia resource and the first content, and if the association degree between the candidate multimedia resource and the first content is greater than a first association degree threshold, the candidate multimedia resource is used as the multimedia resource associated with the first content. In this implementation, a multimedia resource whose content has a relatively large association degree with the content in which the object is interested is used as a related resource, which improves accuracy of the multimedia resource.

In another implementation, the server determines a type label corresponding to the candidate multimedia resource and extracts key information from the candidate multimedia resource. If an association degree (e.g., a second association degree) between the type label and the key information that correspond to the candidate multimedia resource and the type label and the key information that correspond to the first content is greater than a second association degree threshold, the candidate multimedia resource is used as the multimedia resource associated with the first content. In this implementation, a multimedia resource whose type label and key information have a relatively large association degree with those of the content in which the object is interested is used as the related resource, which improves the accuracy of multimedia resource.

In another implementation, if the association degree between the candidate multimedia resource and the first content is greater than the first association degree threshold, and if the association degree between the type label and the key information that correspond to the candidate multimedia resource and the type label and the key information that correspond to the first content are greater than the second association degree threshold, the candidate multimedia resource is used as the multimedia resource associated with the first content.

In an embodiment, a quantity of candidate multimedia resources may be more than one, and the plurality of candidate multimedia resources are separately determined based on the foregoing operation, to determine whether the candidate multimedia resources are the multimedia resources associated with the first content.

In an embodiment, the first association degree threshold is the same as or different from the second association degree threshold. In an embodiment, an example in which the first association degree threshold is the same as the second association degree threshold is used for description. For example, both the first association degree threshold and the second association degree threshold are 90%.

In an embodiment, the process in which the foregoing server performs searching based on the type label and the key information, to obtain the multimedia resource associated with the first content includes the following operation: the server performs searching based on the type label and the key information, to obtain the plurality of candidate multimedia resources; the server obtains a quantity of times of interaction of each of the plurality of candidate multimedia resources; and the server determines, based on the quantity of times of interaction of each of the plurality of candidate multimedia resources, a multimedia resource associated with the first content from the plurality of candidate multimedia resources.

The quantity of times of interaction of the candidate multimedia resource refers to a quantity of times of interaction performed by an object on the candidate multimedia resource of at least one interaction type. A plurality of interaction types includes searching, browsing, sharing, liking, and commenting. Correspondingly, the quantity of times of interaction includes at least one of a quantity of times of searching, a quantity of times of browsing, a quantity of times of sharing, a quantity of times of liking, and a quantity of times of commenting of the candidate multimedia resource.

In an embodiment, the server uses a candidate multimedia resource that is in the plurality of candidate multimedia resources and whose quantity of times of interaction ranks within preset top positions as the multimedia resource associated with the first content. Alternatively, the server uses a candidate multimedia resource that is in the plurality of candidate multimedia resources and whose quantity of times of interaction exceeds a quantity of times threshold as the multimedia resource associated with the first content.

In an embodiment, the plurality of interaction types have priorities, for example, the quantity of times of searching > the quantity of times of browsing > the quantity of times of sharing > the quantity of times of liking > the quantity of times of commenting. If data of an interaction type of the candidate multimedia resources is missing, the server sorts the candidate multimedia resources according to the foregoing priorities, to filter the multimedia resources.

In an embodiment, when a quantity of times of interaction of a multimedia resource is large, it indicates that the multimedia resource is hot content. Further, such a multimedia resource is recommended to the object, to improve interest of the object, meet a requirement of the object, and further improve user experience.

In an embodiment, a process in which the server determines the multimedia resource is a combination of the foregoing two embodiments. The server first determines, based on the quantity of times of interaction, the plurality of multimedia resources in the plurality of candidate multimedia resources. Then, the multimedia resource associated with the first content is determined based on the association degree corresponding to each of the plurality of target multimedia resources. Alternatively, filtering is first performed based on the association degree, and then filtering is performed based on the quantity of times of interaction.

In an embodiment, a process of performing searching based on the first content, to obtain the multimedia resource associated with the first content is implemented through the foregoing operation 405 and operation 406. In an embodiment, information extraction is performed on the first content, to obtain the text type and the key information, so that searching is more accurate, interference from invalid information is avoided, and searching efficiency can be further improved due to a reduced information amount.

The foregoing operation 405 and operation 406 are merely an implementation for implementing the process, and the process may also be implemented in another implementation. For example, searching is directly performed based on the first content. Details are not described herein again.

407: The server transmits the multimedia resource to the terminal.

In an embodiment, the server further determines resource recommendation information based on a quantity of multimedia resources and a type of the multimedia resource, and transmits both the resource recommendation information and the multimedia resource to the terminal, which further helps the terminal present the resource recommendation information.

In an embodiment, the server transmits the resource recommendation information only to the terminal. The terminal obtains, in response to a resource presentation operation on the resource recommendation information, a multimedia resource indicated by the resource recommendation information from the server.

408: The terminal receives the multimedia resource returned by the server, and displays, on the reading progress indication, the resource recommendation information configured to indicate the received multimedia resource.

In an embodiment, the resource recommendation information includes the type of the multimedia resource and a quantity of multimedia resources of each type. Further, the resource recommendation information further indicates the first content. For example, the resource recommendation information includes "a recommendation result of **".

The type of the multimedia resource includes at least one of a video, an image, a text, and an audio. The type of the multimedia resource that is included in the resource recommendation information is a type name, or an icon element corresponding to the type.

In an embodiment, the terminal determines the resource recommendation information based on the quantity of multimedia resources and the type of the multimedia resource.

In an embodiment, the process in which the terminal displays the resource recommendation information on the reading progress indication includes at least one of the following implementations.

In an implementation, the terminal displays a changed style of the reading progress indication, and displays the resource recommendation information on the reading progress indication whose style is changed. The style includes at least one of a color, a size, and a shape. In this implementation, the style of the reading progress indication is changed, and a difference reminder is performed through a visual style, to notify the object that a new multimedia resource is recommended in this case. In this way, the reading progress indication whose style is changed can attract the gaze of the object, and serves as an effective reminder.

In another implementation, the terminal displays a resource assembly in an adjacent region of the reading progress indication, and displays the resource recommendation information on the resource assembly. In this implementation, the resource assembly is displayed, and the resource recommendation information is displayed on the resource assembly, to avoid obstruction of the reading progress indication that is caused by the resource recommendation information, so that interface display is clearer.

The resource assembly may be a user interface (UI) bubble, and the UI bubble includes a bottom UI and the resource recommendation information. The adjacent region may be an upper region, a lower region, a left region and a right region of the reading progress indication, which is not limited herein.

In an embodiment, at least one of the following implementations is further included.

In an implementation, the terminal highlights the first content. A highlighting manner includes at least one of highlighting the first content, framing the first content, bolding words in the first content and adding an underline to the first content, adding a shade to the first content, or the like, which is not limited herein. In this implementation, highlighting the first content facilitates further confirmation by the object, so that the object can further learn of content indicated by the resource recommendation information. In this way, richness of information output is improved, and the user experience is further improved.

In another implementation, the terminal displays a connection line on the text presentation interface, and two ends of the connection line respectively point to the first content and the reading progress indication. In this implementation, the connection line is displayed, to implement a visual association between the first content and the reading progress indication, which improves a visual display effect, and further facilitates viewing of the multimedia resource.

In this embodiment of this application, the terminal may perform at least one of the foregoing implementations on the first content after determining the first content, or may perform at least one of the foregoing implementations when the terminal displays the resource recommendation information.

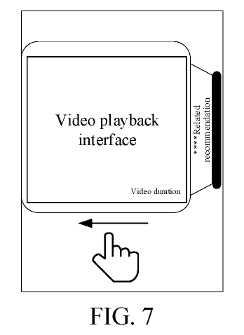

For example, FIG. 6 is a schematic diagram of a text presentation interface according to an embodiment of this disclosure. An example in which a reading progress indication is a navigation bar is used for description. A navigation bar 601 is displayed on the text presentation interface, and a style of the navigation bar changes. A resource assembly is further displayed on the text presentation interface, and resource recommendation information 602 is displayed on the resource assembly. A highlighting box 603 and a connection line 604 of the first content are further displayed on the text presentation interface.

In an embodiment, the resource recommendation information is displayed on the navigation bar, to notify the object that more related content can be viewed. This manner undoubtedly improves motivation of the object to keep viewing. The navigation bar on a side surface may aggregate and display, in real time, more recommended content on the navigation bar according to reading content of the object.

In an embodiment, a process of displaying the resource recommendation information on the reading progress indication is implemented through operation 402 to operation 408. In an embodiment, content currently read by the object is transmitted to the server, and the server determines a related multimedia resource, which reduces service pressure of the terminal. In addition, because the server has a relatively strong service capability, multimedia resources that are rich and accurate enough can be further obtained.

The foregoing operation 402 to operation 408 are merely an implementation for implementing the process, and the process may also be implemented in another implementation. For example, the terminal performs searching based on the first content.

409: In response to the resource presentation operation on the text presentation interface, the terminal presents the multimedia resource indicated by the resource recommendation information.

In an embodiment, the process in which the terminal presents, in response to the resource presentation operation on the text presentation interface, the multimedia resource indicated by the resource recommendation information includes at least one of the following implementations.

In an implementation, in response to a trigger operation on the resource recommendation information, the terminal presents the multimedia resource. In this implementation, the resource recommendation information is triggered, and the multimedia resource indicated by the resource recommendation information is further presented, to ensure consistency of interaction, and improve user experience.

In another implementation, in response to a swiping operation toward a preset direction, the terminal presents the multimedia resource. The preset duration may be set and modified according to a requirement. In an embodiment, an example in which the preset direction is a left direction is used for description. In this implementation, the multimedia resource is presented through the swiping operation, which improves interaction convenience.

In an embodiment, the terminal displays a resource pop-up window on the text presentation interface, and presents the multimedia resource on the resource pop-up window. The resource pop-up window is displayed on a floating layer of the text presentation interface. In an embodiment, the terminal directly presents the multimedia resource on the floating layer of the text presentation interface. In an embodiment, the terminal switches from the text presentation interface to a resource presentation interface, and presents the multimedia resource on the resource presentation interface. In an embodiment, the resource presentation interface is a resource presentation interface presented in response to a search operation. Further, information such as a source of the multimedia resource may be further presented on the resource presentation interface.

For example, FIG. 7 is a schematic diagram of an interface for presenting a multimedia resource according to an embodiment of this disclosure. In response to a left-swiping operation on the text presentation interface, the terminal presents the multimedia resource on the resource pop-up window.

In an embodiment, if a quantity of multimedia resources indicated by the resource recommendation information is more than one, the terminal displays a resource list in response to the resource presentation operation on the text presentation interface. The resource list includes resource covers of the plurality of multimedia resources. In response to a trigger operation on any resource cover, the terminal presents a multimedia resource corresponding to any resource cover.

If the multimedia resource is a video, in response to the trigger operation on the resource cover, a video playback interface is displayed. If the multimedia resource is a text, in response to the trigger operation on the resource cover, a text detail interface is displayed. If the multimedia resource is an image, in response to a trigger operation on the resource cover, an image detail interface is displayed.

In an embodiment, in response to the resource presentation operation, the terminal displays a list pop-up window, and displays the resource list on the list pop-up window. Further, the list pop-up window is displayed on the floating layer of the text presentation interface. Alternatively, the terminal directly displays the resource list on the floating layer of the text presentation interface.

In an embodiment, in response to the trigger operation on the resource cover, the terminal displays a detail pop-up window on the text presentation interface, and presents the multimedia resource on the detail pop-up window. In an embodiment, the detail pop-up window pops up from bottom to top on a screen. Further, the detail pop-up window is displayed on the floating layer of the text presentation interface. A return control is further displayed on the detail pop-up window or the floating layer, and the return control is configured to return to the resource pop-up window. Alternatively, the return control is configured to return to the text presentation interface, to continue to present text content of the text.

The plurality of multimedia resources are sorted in a preset sequence on the resource list. In an embodiment, the plurality of multimedia resources are sorted according to priorities of types. For example, the priorities may be video > image > text > audio. Alternatively, if the plurality of multimedia resources are determined based on an association degree, a multimedia resource with a larger association degree ranks higher. If the plurality of multimedia resources are determined based on a quantity of times of interaction, a multimedia resource with a larger quantity of times of interaction ranks higher.

In an embodiment, if the quantity of multimedia resources is relatively large, and the resource covers of the plurality of multimedia resources cannot be simultaneously displayed, the resource covers of the plurality of multimedia resources are displayed in response to an up-swiping operation and a down-swiping operation on the resource list.

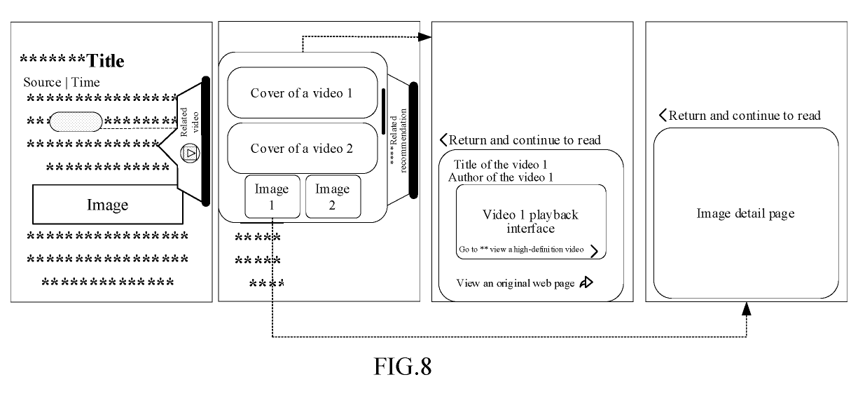

For example, FIG. 8 is a flowchart of presenting a multimedia resource according to an embodiment of this disclosure. Resource recommendation information is displayed on the text presentation interface, for example, a first picture from bottom to top in FIG. 8. In response to the resource presentation operation, the terminal displays the list pop-up window on the text presentation interface, and displays the resource covers of the plurality of multimedia resources on the list pop-up window, for example, a cover of a video 1 and a cover of a video 2 in a second picture from bottom to top in FIG. 8. In response to a trigger operation on a video cover of a video in the multimedia resources, the terminal displays the detail pop-up window, and plays the video on the detail pop-up window, for example, a third picture from bottom to top in FIG. 8. In response to the trigger operation on the video cover of the image in the multimedia resources, the terminal displays the detail pop-up window, and displays detail content of the image on the detail pop-up window, for example, a fourth picture from bottom to top in FIG. 8.

If a quantity of multimedia resource is one, the terminal directly presents the multimedia resource in response to the resource presentation operation on the text presentation interface. Alternatively, the terminal displays a resource cover of the multimedia resource, and the terminal presents the multimedia resource in response to the trigger operation on the resource cover.

In an embodiment, a process of presenting the multimedia resource is implemented through the foregoing operation 401 to operation 409. In an embodiment, after the terminal closes the presented multimedia resource, the terminal continues to present the text. The process is implemented through the following operation 410.

410: In response to a resource closing operation on the text presentation interface, the terminal closes the resource pop-up window, and continues to present the text content on the text presentation interface, where the multimedia resource is presented on the resource pop-up window.

In an embodiment, the foregoing process in which the terminal closes the resource pop-up window in response to the resource closing operation on the text presentation interface includes the following operation: in response to the resource closing operation on the text presentation interface, the terminal displays a closing animation of the resource pop-up window, and the closing animation is configured to indicate a process in which the resource pop-up window contracts to the reading progress indication. In an embodiment, a transition animation is displayed in the process of closing the resource pop-up window, to improve an interface display effect.

In an embodiment, after the resource pop-up window is closed, the resource recommendation information continues to be displayed on the reading progress indication, and the multimedia resource can be further presented again in response to the resource presentation operation again.

In an embodiment, the resource closing operation is a swiping operation toward a target direction. In an example, the target direction is an upward direction is used for description. In an embodiment, a close control is displayed on the resource pop-up window, and the terminal closes the resource pop-up window in response to a trigger operation on the close control.

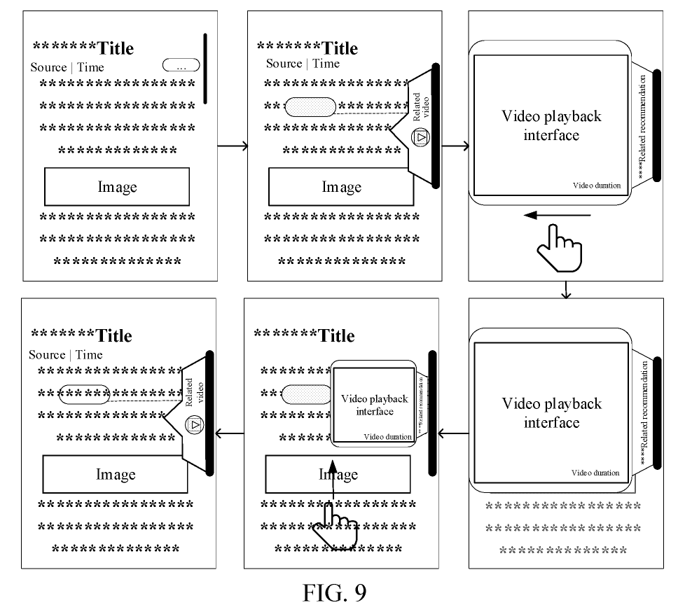

For example, FIG. 9 is a flowchart of presenting a multimedia resource according to an embodiment of this disclosure. An example in which the reading progress indication is the navigation bar is used for description. The terminal presents the text content of the text on the text presentation interface. For example, a first picture from left to right among three pictures in a first line in FIG. 9. In response to a case in which a display position of the navigation bar does not change within the preset duration, the resource recommendation information is displayed on the navigation bar, for example, a second picture from left to right among three pictures in the first line in FIG. 9. In response to a left-swiping operation, a video is played. The left-swiping operation is, for example, shown in a third picture from left to right among three pictures in the first line in FIG. 9. An interface for playing the video is, for example, shown in a first picture from right to left among three pictures in a second line in FIG. 9. In response to an up-swiping operation, the video is closed, and the text content of the text continues to be presented on the text presentation interface. The up-swiping operation is shown in a second picture from right to left among three pictures in the second line in FIG. 9. The text content of the text continues to be presented on the text presentation interface. For example, the text content of the text is shown in a third figure from right to left among three pictures in the second line in FIG. 9.

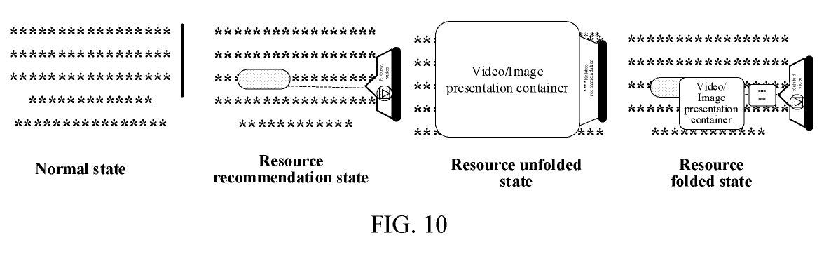

For example, FIG. 10 is a flowchart of an interface of an interaction process of a navigation bar according to an embodiment of this disclosure. The navigation bar has different states in different cases, which are respectively a regular state, a resource recommendation state, a resource unfolded state, and a resource folded state.

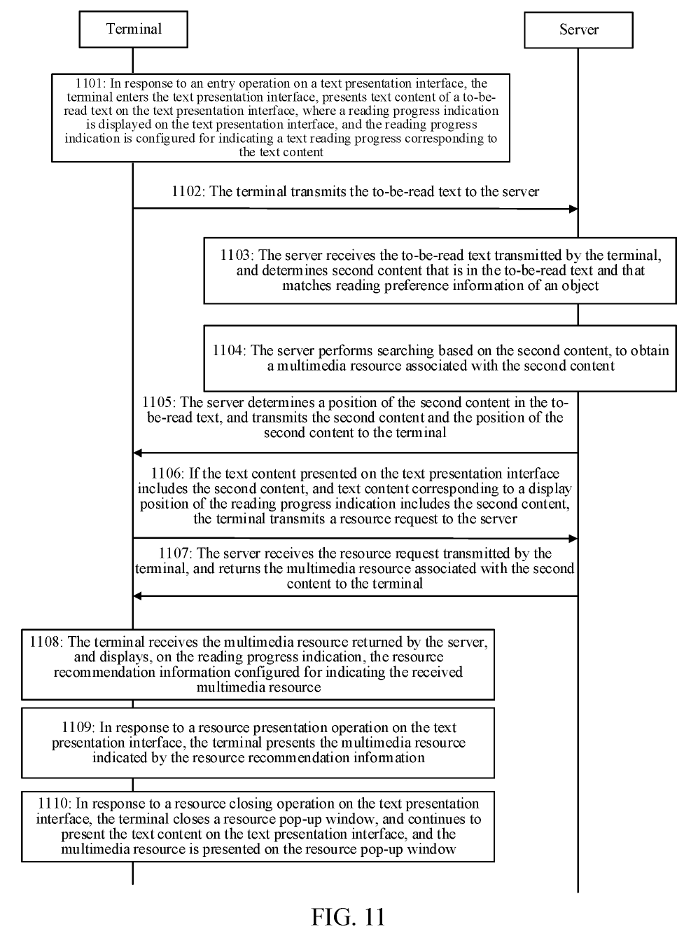

The process in which the multimedia resource is recommended to the object when the text reading progress indicated by the reading progress indication does not change within the preset duration is described through the embodiment of FIG. 4. The following describes, based on the an embodiment of FIG. 11, a process of recommending a multimedia resource to an object based on a reading preference of the object. FIG. 11 shows a multimedia resource presentation method according to an embodiment of this disclosure. The method is described by using interaction between a terminal and a server as an example. The method includes the following operations.

1101: In response to an entry operation on a text presentation interface, the terminal enters the text presentation interface, and presents text content of a to-be-read text on the text presentation interface, where a reading progress indication is displayed on the text presentation interface, and the reading progress indication is configured to indicate a text reading progress corresponding to the text content.

In an embodiment, the entry operation on the text presentation interface may be set and modified according to a requirement. For example, an entry control of the text presentation interface is displayed on the terminal. In response to a trigger operation on the text presentation interface, the terminal displays the text presentation interface. For another example, a text cover of the text is displayed on the terminal. In response to a trigger operation on the text cover, the terminal displays the text presentation interface.

1102: The terminal transmits the to-be-read text to the server.

In an embodiment, after entering the text presentation interface to present the text, the terminal transmits the to-be-read text, that is, entire content of the to-be-read text, to the server.

1103: The server receives the to-be-read text transmitted by the terminal, and determines second content that is in the to-be-read text and that matches reading preference information of the object.

In an embodiment, the reading preference information of the object is obtained based on historical reading information of the object. The reading preference information of the object is configured to indicate text content that the object prefers reading, such as a city favored by the object, a gender preference, a content preference, and a reading habit. The content preference may include a preferred style, field, or the like.

In an embodiment, the terminal obtains the historical reading information of the object in a case in which authorization of the object is obtained. An authorization interface is displayed on the terminal used by the object, and prompt information, an OK control, and a NO control are displayed on the authorization interface. The prompt information is configured to obtain the historical reading information of the object. The OK control is configured to indicate that the object has granted permission for the terminal to obtain the historical reading information of the object. In response to a trigger operation on the OK control, the terminal obtains the historical reading information of the object, and transmits the historical reading information to the server. The server determines the reading preference information based on the historical reading information. Alternatively, after obtaining the historical reading information, the terminal determines the reading preference information based on the historical reading information, and transmits the reading preference information to the server.

1104: The server performs searching based on the second content, to obtain a multimedia resource associated with the second content.

In an embodiment, the second content may be a paragraph, a sentence, or a word. The process in which the server performs searching based on the second content is similar to the process of performing searching based on the type label and the key information in operation 406, and details are not described herein again.

1105: The server determines a position of the second content in the to-be-read text, and transmits the second content and the position of the second content to the terminal.

In an embodiment, based on the position of the second content in the to-be-read text, it may be determined whether the second content is located at a position corresponding to a display position of the reading progress indication.

In an embodiment, the server transmits the second content to the terminal, and the terminal determines, based on the second content, the position of the second content in the to-be-read text. Alternatively, the server transmits the position of the second content to the terminal, and the terminal determines the second content based on the position of the second content.

1106: If the text content presented on the text presentation interface includes the second content, and the text content corresponding to the display position of the reading progress indication includes the second content, the terminal transmits a resource request to the server.

The resource request is configured to obtain the multimedia resource associated with the second content.

In an embodiment, if the reading progress indication is set on the text presentation interface, content read by the object is the text content corresponding to the display position of reading progress indication. Therefore, when the text content corresponding to the display position of the reading progress indication includes the second content, the object is reading the second content in this case, and the resource request is further triggered in this case. In this case, the multimedia resource can be recommended to the object, which matches a reading behavior of reading the second content by the object, to ensures an accurate occasion for resource recommendation.

In an embodiment, if the text content presented on the text presentation interface includes the second content, the terminal transmits the resource request to the server. In an embodiment, because the text content presented on the text presentation interface includes the second content, the object may be reading the second content in this case, and the resource request is triggered in this case. In this case, the multimedia resource can be recommended to the object, which matches the reading behavior of reading the second content by the object, to ensure the accurate occasion for the resource recommendation.

1107: The server receives the resource request transmitted by the terminal, and returns the multimedia resource associated with the second content to the terminal.

In an embodiment, the resource request carries a content identifier of the second content. The server obtains, based on the content identifier, the multimedia resource associated with the second content, and further returns the multimedia resource to the terminal.

1108: The terminal receives the multimedia resource returned by the server, and displays, on the reading progress indication, the resource recommendation information configured to indicate the received multimedia resource.

In an embodiment, the terminal further performs at least one of the following implementations on the second content. After obtaining the second content, the terminal highlights the second content. The terminal displays a connection line on the text presentation interface, and two ends of the connection line respectively point to the second content and the reading progress indication. In an embodiment of this disclosure, the terminal may perform at least one of the foregoing implementations on the second content after determining the second content, or may perform at least one of the foregoing implementations when the terminal displays the resource recommendation information.

1109: In response to a resource presentation operation on the text presentation interface, the terminal presents the multimedia resource indicated by the resource recommendation information.

1110: In response to a resource closing operation on the text presentation interface, the terminal closes a resource pop-up window, and continues to present the text content on the text presentation interface, and the multimedia resource is presented on the resource pop-up window.

In an embodiment, operation 1108 to operation 1110 are similar to operation 408 to operation 410, and details are not described herein again.

The foregoing uses an example in which the entire text is transmitted to the server in advance, and the server finds in advance the multimedia resource related to content in the text for description. In an embodiment, the server determines in advance the second content that is in the entire content of the text and that matches the reading preference information of the object, and further determines in advance the multimedia resource associated with the second content. When the object reads the second content, the terminal directly obtains the multimedia resource from the server without needing to perform searching, so that efficiency of obtaining the multimedia resource is improved, efficiency of presenting the multimedia resource may be further improved, and timeliness is improved.

In an embodiment, in response to a content switching operation on the text presentation interface, the terminal displays the text content of the text, and transmits the text content to the server. The server determines third content that is in the text content and that matches the reading preference information of the object, further determines a multimedia resource associated with the third content, and transmits the third content and a position of the third content to the terminal. The terminal obtains the multimedia resource from the server in response to a case in which the position corresponding to the display position of the reading progress indication includes the position of the third content. In an embodiment, the server only needs to determine the multimedia resource based on the content that is in the content presented on the text presentation interface and that matches the reading preference information, and does not need to determine the multimedia resource based on the content that is in the entire text and that matches the reading preference information. Because the object may not completely read the entire content of the text, that is, the terminal may not completely present the entire content of the text, processing only the presented content may save resources.

The embodiment of FIG. 4 and the embodiment of FIG. 11 may be performed in combination, to further provide richer multimedia resources.

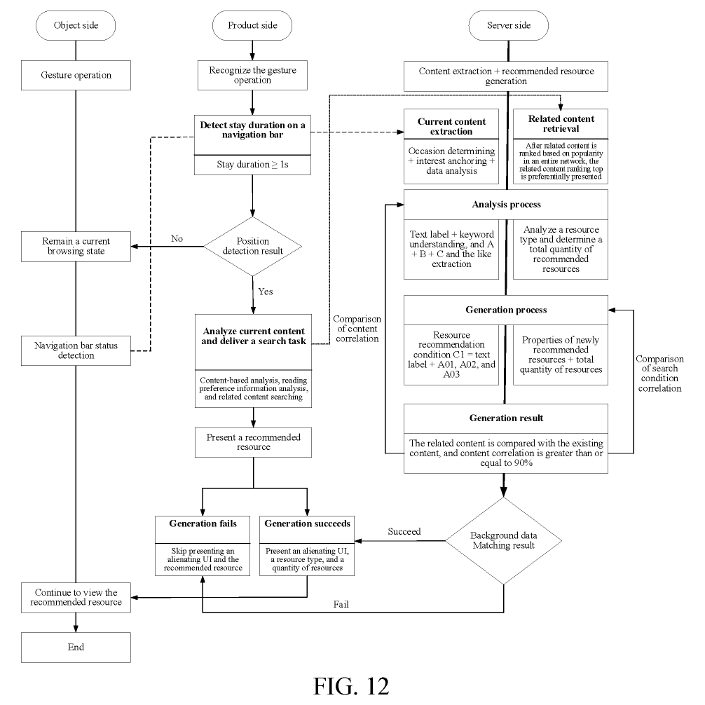

For example, FIG. 12 is a logic flowchart of presenting a multimedia resource according to an embodiment of this disclosure. An example in which the reading progress indication is a navigation bar is used for description. A logic process includes interaction among three parts: an object side, a product side, and a server side. On the object side, the object opens the text presentation interface based on a gesture operation, and the object may remain in a current browsing state, to further perform detection on a navigation bar state, to obtain the resource recommendation information, so as to continuously view a recommended multimedia resource. On the product side, the terminal recognizes the gesture operation, and detects whether stay duration of the navigation bar is greater than or equal to 1 second, to obtain a detection result of a display position of the navigation bar. If the stay duration of the navigation bar is greater than or equal to 1 second, that is, the object remains in the current browsing state, the terminal analyzes currently presented content and delivers a search task to the server, and the server performs searching based on the current content. Further, the server performs searching based on the reading preference information of the object. Then, the terminal presents the multimedia resource. If the server finds the multimedia resource, that is, generation of the multimedia resource succeeds, a navigation bar with a varied style, a type of the multimedia resource, and a quantity of multimedia resources are presented. If generation of the multimedia resource fails, the navigation bar with the varied style and the resource recommendation information are not presented. On the server side, the server is configured to perform content extraction and multimedia resource generation. The server extracts current content, and then retrieves related content. Then, an analysis process and a generation process are performed, to obtain a generation result, and correlation matching is performed on the generation result. When the correlation is met, it is determined that generation of the multimedia resource succeeds. When the correlation is not met, generation of the multimedia resource fails.

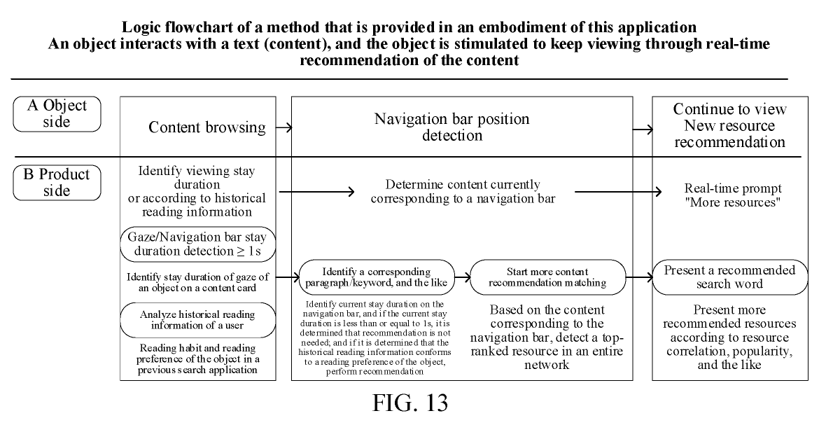

For example, FIG. 13 is a logic flowchart of presenting a multimedia resource according to an embodiment of this disclosure. An example in which a reading progress indication is a navigation bar is used for description. A logic process includes two parts: an object side and a product side. On the object side, the object browses content, detects a position of the navigation bar, and continuously views a newly recommended resource. On the product side, content corresponding to the display position of the navigation bar is determined by recognizing viewing stay duration of the object or according to the historical reading information, and "more content" is prompted in real time.

The method provided in an embodiment of this disclosure may be applied to a picture and text reading scenario in a search application. A navigation bar on a side surface is linked to the text content, and the navigation bar may correspond to an entire paragraph, content in a plurality of lines, or the like, that is, information is recommended and displayed in a linked manner. A seamless experience mode in which the object performs both reading and shopping is formed in a manner in which the navigation bar and the text are presented in a linked manner. The terminal detects stay duration during which the object stays on the text presentation interface, to determine that a paragraph or a keyword in the text can arouse interest of the object to some extent. In addition, according to the historical reading information of the object, a reading preference of the object, such as a category in which the object is interested and a preference, is obtained When the first two cases are met, information is presented on the navigation bar in a superposing manner, and a related resource can be viewed through swiping interaction on the object side. In an embodiment of this disclosure, the related content in which more objects are interested is recommended and presented immediately in a comprehensive experiencing manner including gaze detection, preference analysis of the object, navigation bar interaction, and more content recommendation, so that costs of obtaining information by the object are quickly reduced, matching accuracy of a recommended word is greatly improved, effective reachability efficiency of existing information of the search application is improved, resource obtaining efficiency is improved, and user experience and user stickiness are greatly increased.

The method provided in an embodiment of this disclosure improves timeliness, accuracy, and interactivity of recommended content interaction from the following several aspects. In terms of a matching degree of more content, based on massive content included in the search application, and considering a current real-time recommendation demand of the object, the recommended content with higher quality is presented to a user more quickly and precisely according to content that the object may like. In interaction experience, a product is designed in a manner in which swiping is experiencing. After aggregation information tips (tips) are presented on the navigation bar on the side surface, after the object swipes left, a currently recommended resource may be unfolded, and if the object continues to swipe up, the recommended resource may be presented. After reading is completed, the navigation bar may be seamlessly retracted, and a previous text continues to be presented, so that a reading habit is more coherent and natural. In terms of a user mental model, costs of obtaining more related resources may be greatly reduced, so that an application can live up to a psychological expectation generated by the object in real time, and pleasure in a resource experiencing process may be greatly improved. In addition, in the method, use duration per user of a product can be greatly increased, use stickiness of the user can be greatly increased. The method focuses on interactive recommendation and consumption experience of text reading on the search application. Through observing the viewing stay duration of the object on the content and the historical reading information, "more content" is aggregated on the navigation bar on the side surface in real time, and the object can complete, through gesture interaction, an immersive consumption experience process of the recommended content. The method is based on a content recommendation manner of "understanding-recommendation-interaction consumption", and achieves a new content interaction form in content matching and interaction experience, so that a user can continuously consume, in a seamless manner, the content in which the user is interested, and consumption experience on product content is greatly improved.

The method provided in an embodiment of this disclosure may be summarized into three phases: occasion determining, interest anchoring, and data analysis. Occasion determining includes: determining a text position of the navigation bar in real time, and determining the stay duration of the object on current content (including: a paragraph, a statement, a keyword, and the like) in real time. If the stay duration is greater than or equal to 1 second, it is determined that the object is relatively interested in the content, and this occasion may be used as an optimal occasion for extracting key information. Interest anchoring includes: The server analyzes the reading preference information of the object, which includes a gender, a city, a hobby, a content preference, a consumption habit, and the like, and the information is obtained by analyzing the historical reading information. Interest may be used as an important determining criterion. After the object taps and enters the text presentation interface, an interest keyword of an article is scanned, to match the interest keyword with the reading preference information. When the content overlaps, a recommendation prompt is displayed on the navigation bar. Data analysis includes: obtaining, with reference to the foregoing two interaction forms and information obtaining methods, a corresponding content search condition, performing analysis and storing, and performing recommendation and presentation when an interaction node is reached.

According to the method provided in an embodiment of this disclosure, the viewing stay duration of the object on the content is observed, and with reference to the swiping behavior and the state of the navigation bar, more recommended content is presented on the navigation bar in a linked manner. In this way, an "understanding-recommendation-presentation" content recommendation manner is created. In this solution, a new content interaction form is achieved in terms of the interaction experience of the navigation bar and recommendation result matching, so that the object can continuously view the content in which the object is interested in a seamless manner, to greatly improve consumption experience on the product content. beneficial effects that are achieved include, but are not limited to, the following several aspects.

In a first aspect, newly recommended content better conforms to a viewing expectation of the object. In terms of matching precision of the content, based on the massive content of the search application, and considering the current real-time demand of the object, more related recommendations with higher quality may be presented to the object more quickly and precisely according to the content that the object may like. In a second aspect, a reputation is greatly improved. From a perspective of interactive experience, a product is to be designed in a manner of "sense uniformization". When gaze of the object stays on a piece of content over 1 second, an up-swiping operation is not performed, and a gazing behavior is also generated, the newly recommended content can be seamlessly displayed in an interaction process, and the reading habit of the object is more coherent and natural, which can greatly reduce costs of obtaining the related information by the object. In this way, the platform lives up to a psychological expectation of the object for "generation in real time", and pleasure of the object in an information experiencing process is greatly increased. In a third aspect, use duration of the product is greatly increased. In terms of a product reputation and market feedback, the product reputation can be greatly improved, and use duration per user for the product can be increased, so that the user stickiness is greatly increased. In a fourth aspect, a status of the navigation bar is updated in real time, and an attribute and an amount of associated information are presented in a timely manner. In this way, continuous cognition is more easily formed in psychology the object, so that a mental model of continuous viewing is formed. Each time a change is seen, an expectation of tapping is generated, which can greatly increase duration for continuous viewing by the object.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

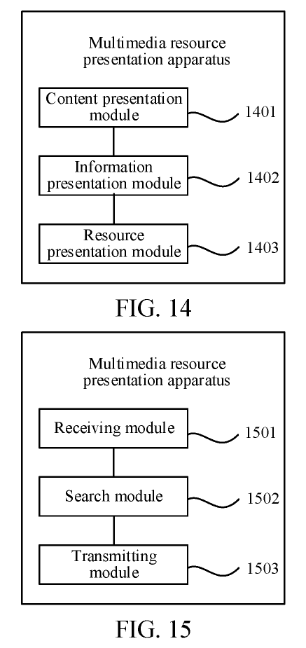

FIG. 14 is a block diagram of a multimedia resource presentation apparatus according to an embodiment of this disclosure. Referring to FIG. 14, the apparatus includes:

a content presentation module 1401, configured to present text content of a to-be-read text on a text presentation interface, a reading progress indication being displayed on the text presentation interface, and the reading progress indication being configured to indicate a text reading progress corresponding to the text content;

an information presentation module 1402, configured to display resource recommendation information if the text reading progress indicated by the reading progress indication does not change within preset duration, the resource recommendation information being configured to indicate a multimedia resource, and the multimedia resource being a multimedia resource associated with the presented text content; and

a resource presentation module 1403, configured to present, in response to a resource presentation operation on the text presentation interface, the multimedia resource indicated by the resource recommendation information.

In an embodiment, the information presentation module 1402 is configured to:

display the resource recommendation information on the reading progress indication.

In an embodiment, the information presentation module 1402 is configured to:

determine first content from the text content;

transmit the first content to a server, the server being configured to determine the multimedia resource based on the first content; and

receive the multimedia resource returned by the server, and display the resource recommendation information configured to indicate the received multimedia resource.

In an embodiment, the information presentation module 1402 is configured to perform at least one of the following:

determining the text content as the first content;

determining content corresponding to a display position of the reading progress indication in the text content as the first content; and

determining, based on gaze detection, content corresponding to gaze of the object, and determine, if the content corresponding to the gaze of the object belongs to the content corresponding to the display position of the reading progress indication, the content corresponding to the gaze of the object as the first content.

In an embodiment, a content display module is further configured to perform at least one of the following:

highlighting the first content; and

displaying a connection line on the text presentation interface, two ends of the connection line respectively pointing to the first content and the reading progress indication.

In an embodiment, the information presentation module 1402 is configured to:

display the resource recommendation information if determining, through the gaze detection, that the gaze of the object stays on the text presentation interface, and the text reading progress indicated by the reading progress indication does not change within the preset duration.

In an embodiment, the resource presentation module 1403 is configured to:

display a resource list in response to the resource presentation operation on the text presentation interface if a quantity of multimedia resources indicated by the resource recommendation information is more than one, the resource list including resource covers of the plurality of multimedia resources; and

present, in response to a trigger operation on any resource cover, a multimedia resource corresponding to any resource cover.

In an embodiment, the apparatus further includes a determining module, configured to determine second content in the to-be-read text, the second content being content that is in the to-be-read text and that matches reading preference information of the object; and

the information presentation module 1402, further configured to display the resource recommendation information based on the second content if the text content presented on the text presentation interface includes the second content, the resource recommendation information being configured to indicate a multimedia resource associated with the second content; or display the resource recommendation information based on the second content if the text content presented on the text presentation interface includes the second content, and the text content corresponding to the display position of the reading progress indication includes the second content.

In an embodiment, the resource recommendation information includes a type of a multimedia resource and a quantity of multimedia resources of each type.

In an embodiment, the resource presentation module 1403 is configured to:

present the multimedia resource in response to a trigger operation on the resource recommendation information; or

present the multimedia resource in response to a swiping operation toward a preset direction.

In an embodiment, the multimedia resource is presented on a resource pop-up window, and the apparatus further includes:

a closing module, configured to close the resource pop-up window in response to a resource closing operation on the text presentation interface, the text content continuing to be presented on the text presentation interface.

In an embodiment, the closing module is configured to:

display a closing animation of the resource pop-up window in response to the resource closing operation on the text presentation interface, the closing animation being configured to indicate a process in which the resource pop-up window contracts to the reading progress indication.

In an embodiment, the information presentation module 1402 is configured to perform at least one of the following:

displaying a changed style of the reading progress indication, and displaying the resource recommendation information on the reading progress indication whose style is changed, the style including at least one of a color, a size, and a shape; and

displaying a resource assembly in an adjacent region of the reading progress indication, and displaying the resource recommendation information on the resource assembly.

An embodiment of this disclosure provides a multimedia resource presentation apparatus. When the object reads the text, the apparatus displays the text content in the to-be-read text on the text presentation interface. The reading progress indication is further displayed on the text presentation interface. The reading progress indication is configured to indicate the text reading progress corresponding to the presented text content. In other words, the text reading progress indicated by the reading progress indication does not change, which indicates that the text content read by the object does not change. If the text reading progress indicated by the reading progress indication does not change within the preset duration, it indicates that the object keeps viewing the currently presented text content, that is, the object is interested in the currently presented text content. However, in this case, the resource recommendation information is displayed, to remind the object that the multimedia resource associated with the currently presented text content is recommended, so that after the object performs the interaction operation, the recommended multimedia resource can be viewed and the object does not need to switch to another interface to search for the related multimedia resource, which improves interaction efficiency. In addition, the method is used to determine content in which the object is interested based on a reading behavior of the object, so that the determined content in which the object is interested is accurate. Further, the multimedia resource related to the content in which the object is interested is recommended to the object, which improves accuracy of the multimedia resource recommendation. The method improves the interaction efficiency, and ensures the accuracy of multimedia resource recommendation.

FIG. 15 is a block diagram of a multimedia resource presentation apparatus according to an embodiment of this disclosure. Referring to FIG. 15, the apparatus includes:

a receiving module 1501, configured to receive first content transmitted by a terminal, the first content being text content in a to-be-read text that is presented on a text presentation interface of the terminal, a reading progress indication configured to indicate a text reading progress corresponding to the presented text content being displayed on the text presentation interface, and the terminal being configured to transmit the first content when the text reading progress indicated by the reading progress indication does not change within preset duration;

a search module 1502, configured to perform searching based on the first content, to obtain a multimedia resource associated with the first content; and

a transmitting module 1503, configured to transmit the multimedia resource to the terminal, the terminal being configured to present resource recommendation information to indicate the multimedia resource.

In an embodiment, the search module 1502 is configured to:

determine a type label of the to-be-read text based on the first content, and extract key information in the first content;

perform searching based on the type label and the key information, to obtain the multimedia resource associated with the first content.

In an embodiment, the search module 1502 is configured to:

perform searching based on the type label and the key information, to obtain a candidate multimedia resource; and

determine an association degree between the candidate multimedia resource and the first content, and use, if the association degree between the candidate multimedia resource and the first content is greater than a first association degree threshold, the candidate multimedia resource as the multimedia resource associated with the first content; or

determine a type label corresponding to the candidate multimedia resource and extract key information from the candidate multimedia resource, and use, if the association degree between the type label and the key information that correspond to the candidate multimedia resource and the type label and the key information that correspond to the first content is greater than a second association degree threshold, the candidate multimedia resource as the multimedia resource associated with the first content.

In an embodiment, the search module 1502 is configured to:

perform searching based on the type label and the key information, to obtain a plurality of candidate multimedia resources;

obtain a quantity of interaction times of each of the plurality of candidate multimedia resources; and

determine, based on the quantity of interaction times of each of the plurality of candidate multimedia resources, a multimedia resource associated with the first content from the plurality of candidate multimedia resources.

In an embodiment, the receiving module 1501 is further configured to receive the to-be-read text.

The apparatus further includes a determining module, configured to determine second content that is in the to-be-read text and that matches reading preference information of an object;

the search module 1502, further configured to perform searching based on the second content, to obtain a multimedia resource associated with the second content;

the determining module, further configured to determine a position of the second content in the to-be-read text, and transmit the second content and the position of the second content to the terminal, the terminal being configured to transmit a resource request when a position corresponding to a display position of the reading progress indication includes the position of the second content; and

the receiving module 1501, further configured to receive the resource request transmitted by the terminal, and return the multimedia resource associated with the second content to the terminal, the terminal being configured to present the multimedia resource associated with the second content.

An embodiment of this disclosure provides the multimedia resource presentation apparatus. When the object reads the text, the apparatus displays the text content in the to-be-read text on the text presentation interface. The reading progress indication is further displayed on the text presentation interface. The reading progress indication is configured to indicate the text reading progress corresponding to the presented text content. In other words, the text reading progress indicated by the reading progress indication does not change, which indicates that the text content read by the object does not change. If the text reading progress indicated by the reading progress indication does not change within the preset duration, it indicates that the object keeps viewing the currently presented text content, that is, the object is interested in the content in the currently presented text content. The text content in which the object is interested, namely, the first content is transmitted to the server in this case, so that the server performs searching based on the first content, to obtain the related multimedia resource, and the related multimedia resource is further returned to the terminal for presenting. In the method, the object does not need to switch to another interface to search for the related multimedia resource, which improves interaction efficiency. In addition, the method is used to determine content in which the object is interested based on a reading behavior of the object, so that the determined content in which the object is interested is accurate. Further, the multimedia resource related to the content in which the object is interested is recommended to the object, which improves accuracy of multimedia resource recommendation. The method improves the interaction efficiency, and ensures the accuracy of multimedia resource recommendation.

In an embodiment, a computer device may be a terminal or a server. When the computer device is the terminal, the terminal is used as an execution body to implement the technical solutions provided in the embodiments of this disclosure. When the computer device is the server, the server is used as an execution body to implement the technical solutions provided in the embodiments of this disclosure. Alternatively, the technical solutions provided in this disclosure are implemented through interaction between the terminal and the server. This is not limited in an embodiment of this disclosure.

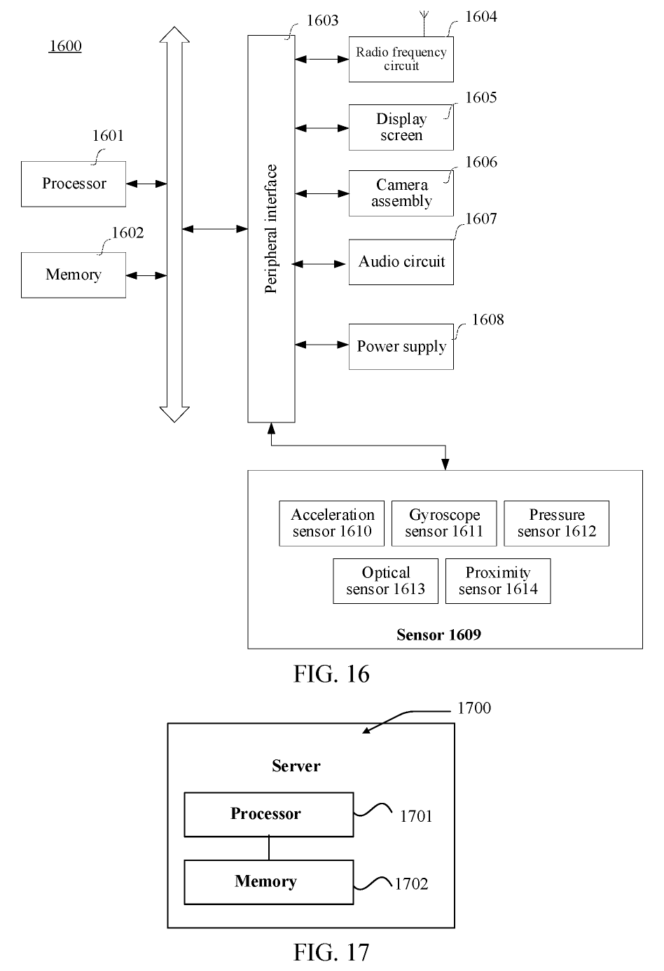

FIG. 16 is a block diagram of a structure of a terminal 1600 according to an embodiment of this disclosure.

For example, the terminal 1600 includes: processing circuitry (e.g., a processor 1601) and a memory 1602.

The processing circuitry (e.g., the processor 1601) may include one or more processing cores, such as a 4-core processor or an 8-core processor. The processor 1601 may be implemented by using at least one hardware form of a digital signal processor (DSP), a field-programmable gate array (FPGA), and a programmable logic array (PLA). The processor 1601 may also include a main processor and a coprocessor. The main processor is a processor configured to process data in an active state, which is also referred to as a central processing unit (CPU). The coprocessor is a low-power consumption processor configured to process data in a standby state. In an embodiment, the processor 1601 may be integrated with a graphics processing unit (GPU). The GPU is configured to render and draw content that needs to be displayed on a display screen. In an embodiment, the processor 1601 may alternatively include an artificial intelligence (AI) processor. The AI processor is configured to process a computing operation related to machine learning.

The memory 1602 may include one or more computer-readable storage media, and the computer-readable storage media may be non-transitory. The memory 1602 may alternatively include a high-speed random access memory and a non-volatile memory, for example, one or more disk storage devices and flash storage devices. In an embodiment, the non-transitory computer-readable storage medium in the memory 1602 is configured to store at least one program code, and the at least one program code is configured to be executed by the processor 1601 to implement the multimedia resource presentation method provided in the method embodiments of this disclosure.

In an embodiment, the terminal 1600 may further selectively include: a peripheral interface 1603 and at least one peripheral. The processor 1601, the memory 1602, and the peripheral interface 1603 may be connected through a bus or a signal cable. Each peripheral may be connected to the peripheral interface 1603 through the bus, the signal cable, or a circuit board. For example, the peripheral includes: at least one of a radio frequency circuit 1604, a display screen 1605, a camera assembly 1606, an audio circuit 1607, and a power supply 1608.

In an embodiment, the terminal 1600 further includes one or more sensors 1609. The one or more sensors 1609 include, but are not limited to: an acceleration sensor 1610, a gyroscope sensor 1611, a pressure sensor 1612, an optical sensor 1613, and a proximity sensor 1614.

A person skilled in the art may understand that the structure shown in FIG. 16 constitutes no limitation on the terminal 1600, and the terminal 1600 may include more or fewer assemblies than those shown in the figure, or some assemblies may be combined, or different assembly arrangement may be used.

FIG. 17 is a schematic diagram of a structure of a server according to an embodiment of this disclosure. The server 1700 may vary greatly due to different configurations or performance, and may include processing circuitry (e.g., one or more processors 1701) and one or more memories 1702. The memory 1702 is configured to store an executable program code, the processor 1701 is configured to execute the foregoing executable program code, to implement the multimedia resource presentation method provided in the foregoing various method embodiments. In an embodiment, the server may further include components such as a wired or wireless network interface, a keyboard, and an input/output interface, to facilitate inputs/outputs. The server may further include another component configured to implement functions of a device. Details are not described herein again.

An embodiment of this disclosure further provides a computer-readable storage medium (e.g., a non-transitory computer-readable storage medium), the computer-readable storage medium stores at least one program, and the at least one program is loaded and executed by a processor, to implement the multimedia resource presentation method in any one of the foregoing implementations. In the embodiments of this disclosure, all the foregoing technical solutions may be arbitrarily combined to form an embodiment of this disclosure, and details are not described herein again.

An embodiment of this disclosure further provides a computer program product. The computer program product includes at least one program, the at least one program is stored in a computer-readable storage medium (e.g., a non-transitory computer-readable storage medium), a processor of a computer device reads the at least one program from the computer-readable storage medium, and the processor executes the at least one program, to enable the computer device to perform the multimedia resource presentation method in any one of the foregoing implementations.

In an embodiment, computer product programs involved in the embodiments of this disclosure may be deployed to be executed on one computer device, or deployed to be executed on a plurality of computer devices at a same location, or deployed to be executed on a plurality of computer devices that are distributed at a plurality of locations and interconnected through a communication network. The plurality of computer devices that are distributed at the plurality of locations and interconnected through the communication network can form a blockchain system.

All the foregoing technical solutions may be combined in various manners to form an embodiment of this disclosure, and details are not described herein again. The foregoing descriptions are merely non-limiting embodiments of this disclosure, and are not intended to limit this disclosure. Any modification, equivalent replacement, improvement, or the like fall within a scope of this disclosure.

What is claimed is:

1. A multimedia resource presentation method, comprising:
displaying text content of to-be-read text;
displaying a reading-progress indicator configured to indicate a reading progress of the text content;
determining whether the reading progress indicated by the reading-progress indicator changes within a preset duration;
displaying resource recommendation information based on the text content and the reading progress indicated by the reading-progress indicator not changing within the preset duration, the resource recommendation information being configured to indicate a multimedia resource associated with the displayed text content;
receiving a resource presentation operation to view the resource recommendation information; and
presenting, by processing circuitry and based on the resource presentation operation, the multimedia resource indicated by the resource recommendation information.

2. The method according to claim 1, wherein the displaying the resource recommendation information comprises:
displaying the resource recommendation information on the reading-progress indicator.

3. The method according to claim 1, wherein the displaying the resource recommendation information comprises:
determining first content from the text content;
transmitting the first content to a server configured to determine the multimedia resource based on the first content;
receiving the multimedia resource from the server; and
displaying the resource recommendation information based on the received multimedia resource.

4. The method according to claim 3, wherein the determining the first content comprises:
determining content from the text content that corresponds to a display position of the reading-progress indicator as the first content.

5. The method according to claim 3, wherein the determining the first content comprises:
determining content from the text content that corresponds to a gaze of a user and a display position of the reading-progress indicator as the first content.

6. The method according to claim 3, further comprising:
displaying an indication of which of the text content corresponds to the first content.

7. The method according to claim 1, wherein the displaying the resource recommendation information comprises:
displaying the resource recommendation information based on a stay duration of a gaze of a user being greater than a threshold.

8. The method according to claim 1, wherein the presenting the multimedia resource comprises:
displaying a resource list based on the resource presentation operation and a quantity of multimedia resources indicated by the resource recommendation information being greater than one, the resource list including graphical representations of the multimedia resources; and
presenting, based on a trigger operation on one of the graphical representations, one of the multimedia resources corresponding to the one of the graphical representations.

9. The method according to claim 1, further comprising:
determining second content in the text content that matches reading preference information of a user; and
displaying the resource recommendation information based on the second content.

10. The method according to claim 1, wherein the resource recommendation information indicates a type of the multimedia resource and a quantity of multimedia resources of each type.

11. The method according to claim 1, wherein the presenting the multimedia resource comprises:
presenting the multimedia resource based on a trigger operation on the resource recommendation information.

12. The method according to claim 1, wherein the multimedia resource is presented via a resource pop-up window, and the method further comprises:
closing, based on a resource closing operation the resource pop-up window; and
continuing to present the text content.

13. An information processing apparatus, comprising:
processing circuitry configured to:
display text content of a to-be-read text;
display a reading-progress indicator configured to indicate a reading progress of the text content;
determine whether the reading progress indicated by the reading-progress indicator changes within a preset duration;
display resource recommendation information based on the text content and the reading progress indicated by the reading-progress indicator not changing within the preset duration, the resource recommendation information being configured to indicate a multimedia resource associated with the displayed text content;
receive a resource presentation operation to view the resource recommendation information; and
present, based on the resource presentation operation, the multimedia resource indicated by the resource recommendation information.

14. The information processing apparatus according to claim 13, wherein the processing circuitry is configured to:
display the resource recommendation information on the reading-progress indicator.

15. The information processing apparatus according to claim 13, wherein the processing circuitry is configured to:
determine first content from the text content;
transmit the first content to a server configured to determine the multimedia resource based on the first content;
receive the multimedia resource from the server; and
display the resource recommendation information based on the received multimedia resource.

16. The information processing apparatus according to claim 15, wherein the processing circuitry is configured to:
determine content from the text content that corresponds to a display position of the reading-progress indicator as the first content.

17. The information processing apparatus according to claim 15, wherein the processing circuitry is configured to:
determine content from the text content that corresponds to a gaze of a user and a display position of the reading-progress indicator as the first content.

18. The information processing apparatus according to claim 15, wherein the processing circuitry is configured to:
display an indication of which of the text content corresponds to the first content.

19. The information processing apparatus according to claim 13, wherein the processing circuitry is configured to:
display the resource recommendation information based on a stay duration of a gaze of a user being greater than a threshold.

20. A non-transitory computer-readable storage medium storing instructions which, when executed by a processor, cause the processor to perform:
displaying text content of a to-be-read text;
displaying a reading-progress indicator configured to indicate a reading progress of the text content;
determining whether the reading progress indicated by the reading-progress indicator changes within a preset duration;
displaying resource recommendation information based on the text content and the reading progress indicated by the reading-progress indicator not changing within the preset duration, the resource recommendation information being configured to indicate a multimedia resource associated with the displayed text content;
receiving a resource presentation operation to view the resource recommendation information; and
presenting, by processing circuitry and based on the resource presentation operation, the multimedia resource indicated by the resource recommendation information.
